(19) United States
(12) Patent Application Publication
(10) Pub. No.: US 2025/0285323 A1
(43) Pub. Date: Sep. 11, 2025

(54) IMAGE PROCESSING SYSTEM AND IMAGE PROCESSING METHOD

(71) Applicant: REALTEK SEMICONDUCTOR CORP., Hsinchu (TW)

(72) Inventors: Cun Wei, Suzhou (CN); Guang-Yu San, Suzhou (CN); Hsin-Ying Ou, Hsinchu (TW)

(73) Assignee: REALTEK SEMICONDUCTOR CORP., Hsinchu (TW)

(21) Appl. No.: 18/949,111

(22) Filed: Nov. 15, 2024

(30) Foreign Application Priority Data
Mar. 11, 2024 (CN) 202410275803.1

(51) Int. Cl. G06T 7/73; G06T 7/50

(52) U.S. Cl. CPC G06T 7/73; G06T 7/50; G06T 2207/30201

(57) ABSTRACT

An image processing system and an image processing method are provided. The image processing method includes: executing the following steps by an object detection module: receiving an image and detecting the image based on an object detection algorithm; and in response to detecting faces, obtaining a range of each face based on a shape of a polygon; executing the following steps by a weight calculation module on a plurality of pixels in a region covered by the ranges of all faces: based on coordinate information of a current pixel among the pixels and position information of each face, obtaining a weight of the current pixel; and in response to there being an unselected pixel among the pixels, selecting the unselected one of the pixels as the current pixel and returning to the aforementioned step of obtaining a weight of the current pixel.

### CROSS-REFERENCE TO RELATED APPLICATION

This non-provisional application claims priority under 35 U.S.C. § 119 (a) to patent application No. 202410275803.1 filed in China, P.R.C. on Mar. 11, 2024, the entire contents of which are hereby incorporated by reference.

### BACKGROUND

### Technical Field

The present disclosure relates to the field of image processing, and in particular, to a technology for adjusting an image based on a face region.

### Related Art

FIG. 1 is a schematic diagram of a face image. Referring to FIG. 1, when the HSI color gamut color and brightness of faces (a face 101 and a face 102) in an image 100 are enhanced in the prior art, a transition region from the center of the face to surrounding parts is often uneven. Especially when a plurality of faces overlap, obvious color and brightness discontinuities are highly prone to appearance: when the image is played on TV, an obvious streak-shaped cut line (such as a cut line 103) will appear at the edge of the face, and there will be obvious brightness and color discontinuities on both sides of the cut line.

### SUMMARY

In view of this, some embodiments of the present disclosure provide an image processing system and an image processing method to improve the problems in the prior art.

An embodiment of the present disclosure provides an image processing system, including an object detection module and a weight calculation module, where the object detection module is configured to execute the following steps: (a1) receiving an image and detecting the image based on an object detection algorithm; and (a2) in response to detecting at least one face, obtaining a range of each face based on a shape of a polygon; where the weight calculation module is configured to execute the following steps on a plurality of pixels in a region covered by the ranges of all faces: (b1) based on coordinate information of a current pixel among the aforementioned pixels and position information of each face, obtaining a weight of the current pixel; and (b2) in response to there being an unselected pixel among the pixels, selecting the unselected one of the pixels as the current pixel and returning to step (b1).

An embodiment of the present disclosure provides an image processing method, including: (a) executing the following steps by an object detection module: (a1) receiving an image and detecting the image based on an object detection algorithm; and (a2) in response to detecting at least one face, obtaining a range of each face based on a shape of a polygon; (b) executing the following steps by a weight calculation module on a plurality of pixels in a region covered by the ranges of all faces: (b1) based on coordinate information of a current pixel among the aforementioned pixels and position information of each face, obtaining a weight of the current pixel; and (b2) in response to there being an unselected pixel among the pixels, selecting the unselected one of the pixels as the current pixel and returning to step (b1).

Based on the above, according to the image processing system and the image processing method provided by some embodiments of the present disclosure, the range of each face is obtained based on the shape of the polygon, and thereby the area of a non-face region and the area of a face overlapping region can be effectively reduced, and thus side effects brought by a non-face part marked as a face region are alleviated; and the weight of a corresponding pixel obtained based on the coordinate information of each pixel in the region covered by the ranges of all faces and the position information of each face can be provided for the post-stage to adjust the brightness and chromaticity based on the weight of the corresponding pixel.

### BRIEF DESCRIPTION OF THE DRAWINGS

FIG. 1 is a schematic diagram of a face image;

FIG. 2 is a block diagram of an image processing system illustrated according to some embodiments of the present disclosure;

FIG. 3 is a schematic diagram of operation of an object detection module illustrated according to some embodiments of the present disclosure;

FIG. 4 is a schematic diagram of generation of face ranges illustrated according to some embodiments of the present disclosure;

FIG. 5A to FIG. 5D are schematic diagrams of operation of an image processing system illustrated according to some embodiments of the present disclosure;

FIG. 6 is a block diagram of a display system illustrated according to some embodiments of the present disclosure;

FIG. 7 is a schematic structural diagram of an electronic device illustrated according to some embodiments of the present disclosure;

FIG. 8 is a flowchart of an image processing method illustrated according to some embodiments of the present disclosure;

FIG. 9 is a flowchart of generation of face ranges illustrated according to some embodiments of the present disclosure;

FIG. 10 is a flowchart of an image processing method illustrated according to some embodiments of the present disclosure;

FIG. 11 is a flowchart of an image processing method illustrated according to some embodiments of the present disclosure;

FIG. 12 is a flowchart of an image processing method illustrated according to some embodiments of the present disclosure;

FIG. 13 is a flowchart of an image processing method illustrated according to some embodiments of the present disclosure;

FIG. 14 is a flowchart of an image processing method illustrated according to some embodiments of the present disclosure;

FIG. 15 is a flowchart of an image processing method illustrated according to some embodiments of the present disclosure; and

FIG. 16 is a flowchart of an image processing method illustrated according to some embodiments of the present disclosure.

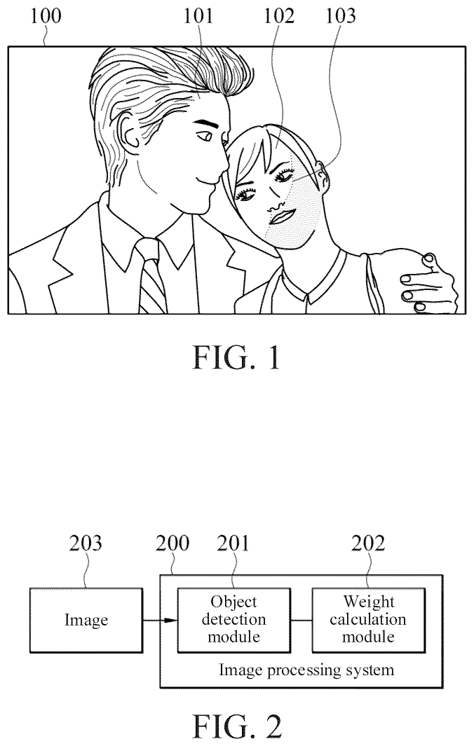

### DETAILED DESCRIPTION

The aforementioned and other technical contents, features and effects of the present disclosure are clearly presented in the following detailed descriptions of embodiments with reference accompanying drawings. Anything that does not affect the efficacy that the present disclosure can produce and the purpose that can be achieved shall still fall within the scope of the technical content disclosed by the present disclosure.

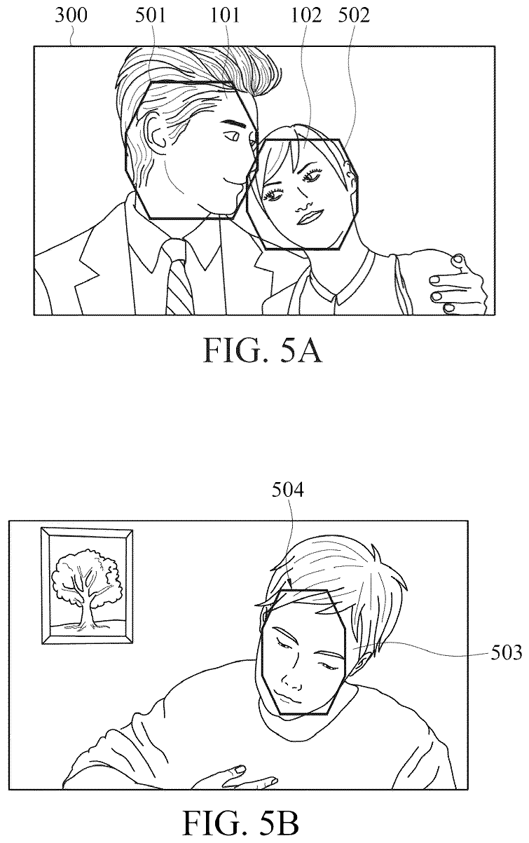

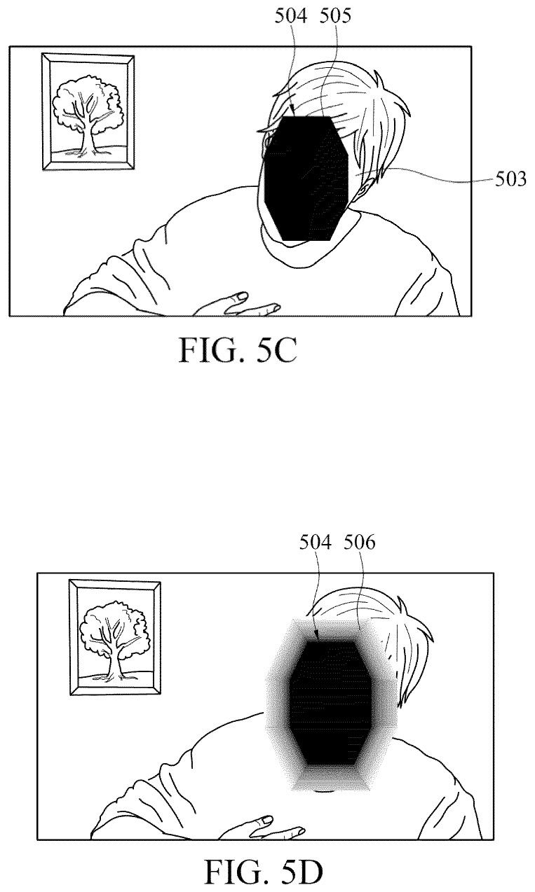

FIG. 2 is a block diagram of an image processing system illustrated according to some embodiments of the present disclosure. FIG. 5A is a schematic diagram of operation of an image processing system illustrated according to some embodiments of the present disclosure. Referring to FIG. 2 and FIG. 5A, an image processing system 200 includes an object detection module 201 and a weight calculation module 202. The object detection module 201 is configured to receive an image 203 and detect the image 203 based on an object detection algorithm. The object detection algorithm is, for example, Faster R-CNN, SSD, YOLO or other object detection algorithms. The object detection module 201 is configured to obtain a range of each face based on a shape of a polygon when faces are detected in the image 203.

Taking FIG. 5A as an example, in some embodiments, the polygon is an octagon. The object detection module 201 detects a face 101 and a face 102 in an image 300. The object detection module 201, in response to detecting the face 101 and the face 102, obtains ranges of the face 101 and the face 102 based on a shape of the octagon, where the ranges of the face 101 and the face 102 are ranges included in an octagonal box 501 and an octagonal box 502, respectively. The weight calculation module 202 is configured to calculate a weight for each pixel included in a region covered by ranges of all detected faces (e.g., the ranges of the face 101 and the face 102).

The image processing method of some embodiments of the present disclosure and how modules of the image processing system 200 thereof cooperate with each other will be described below in details with the accompanying drawings.

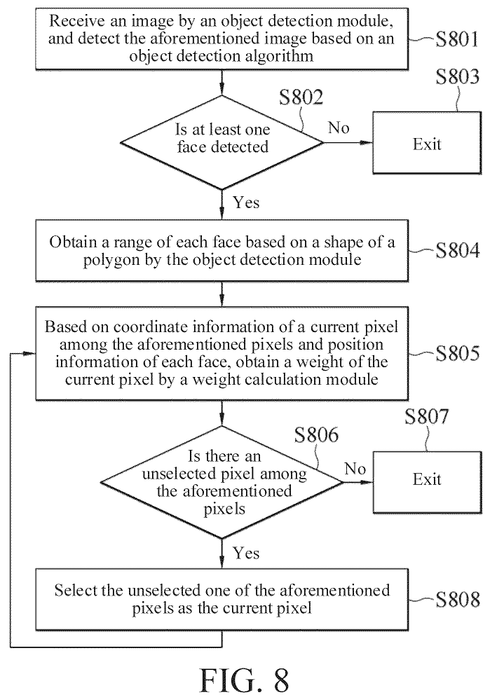

FIG. 8 is a flowchart of an image processing method illustrated according to some embodiments of the present disclosure. Referring to FIG. 2, FIG. 5A and FIG. 8, in an embodiment of FIG. 8, the image processing method includes steps S801 to S808. In step S801, an image (e.g., image 203) is received by the object detection module 201 and the aforementioned image is detected based on an object detection algorithm to detect whether a face is present in the image or not. In step S802, if the object detection module 201 judges that no face is detected, then proceed to step S803 to exit the current procedure to process a next image received by the object detection module 201. If the object detection module 201 detects at least one face in the image, proceed to step S804. In step S804, in response to detecting at least one face, a range of each face is obtained based on a shape of a polygon (e.g., the octagon shown in FIG. 5A above) by the object detection module 201. In step S805, for a current pixel which has not been unselected among pixels in a region covered by the ranges of all faces, based on coordinate information of the current pixel and position information of each face, a weight of the current pixel is obtained by the weight calculation module 202.

In step S806, whether there is still an unselected pixel that is unselected for weight calculation among the pixels in the region covered by the ranges of all faces or not is judged by the weight calculation module 202. If yes, proceed to step S808, and if no, proceed to step S807 to exit the current procedure such that the remaining modules can process the pixels in the region covered by the ranges of all faces (e.g., brightness adjustment or chroma adjustment) by using weights of the pixels in the region covered by the ranges of all faces. In step S808, in response to there being an unselected pixel among the pixels in the region covered by the ranges of all faces, the unselected one of the pixels in the region covered by the ranges of all faces is selected as the current pixel by the weight calculation module 202 and returns to step S805 to re-execute steps S805 to S808.

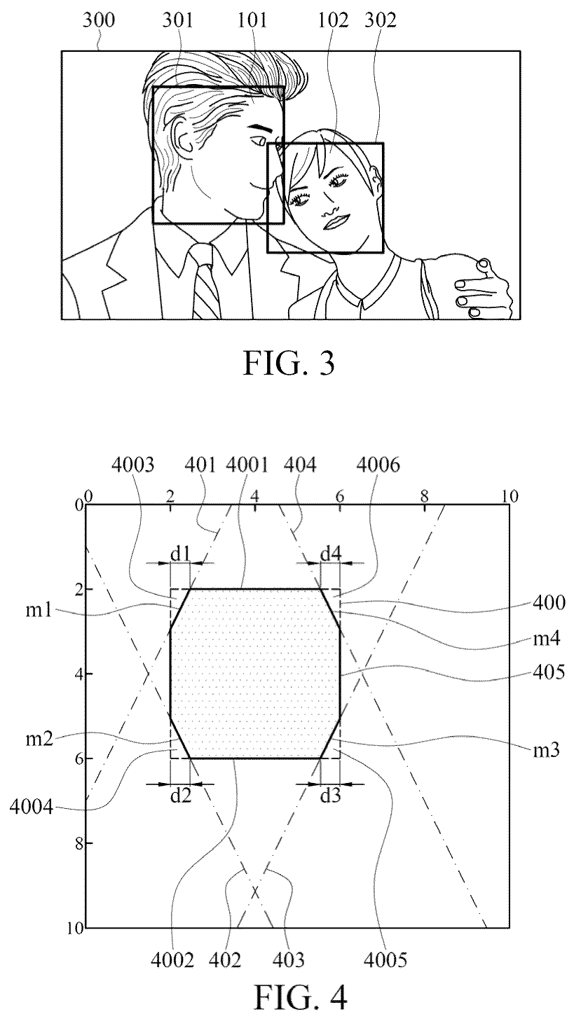

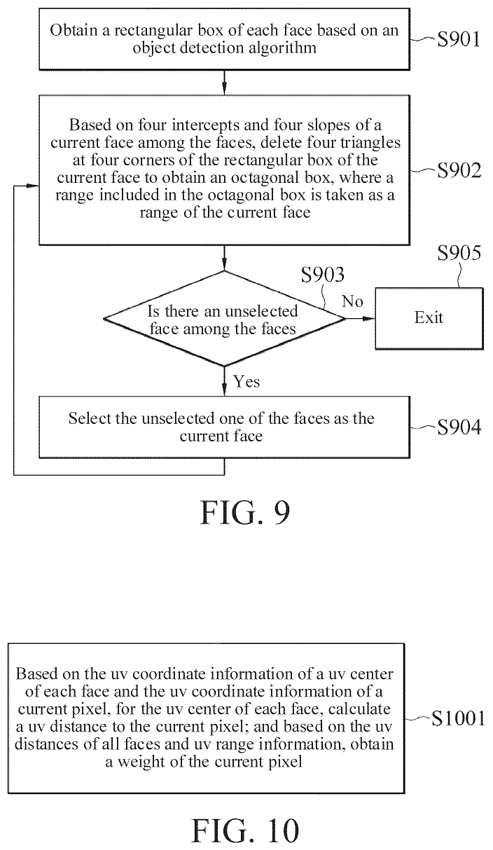

FIG. 3 is a schematic diagram of operation of an object detection module illustrated according to some embodiments of the present disclosure. FIG. 4 is a schematic diagram of generation of face ranges illustrated according to some embodiments of the present disclosure. FIG. 9 is a flowchart of generation of face ranges illustrated according to some embodiments of the present disclosure. Referring to FIG. 2 to FIG. 4 and FIG. 9, in an embodiment of FIG. 9, the polygon is an octagon, and the image processing method includes executing steps S901 to S905 by the object detection module 201. In step S901, a rectangular box of each face in a received image is obtained based on an object detection algorithm. Taking FIG. 3 as an example, the object detection module 201 detects the face 101 and the face 102 in the image 300, and the object detection module 201 obtains a rectangular box 301 of the face 101 and a rectangular box 302 of the face 102 based on the object detection algorithm.

After step S901, rectangular boxes of detected faces are sequentially processed by the object detection module 201 to obtain a range of each face. In step S902, based on four intercepts and four slopes corresponding to a current face among at least one detected face, four triangles at four corners of the rectangular box of the current face are deleted to obtain an octagonal box, and the object detection module 201 takes a range included in the octagonal box as the range of the current face. In step S903, whether there is an unselected face among the at least one detected face or not is judged. If no, proceed to step S905 and exit the current procedure. If yes, execute step 904. In step 904, in response to there being an unselected face among the at least one face, the unselected one of the at least one face is selected as the current face and return to step S902 to re-execute steps S902 to S905.

Taking FIG. 4 as an example, the rectangular box of the current face obtained by the object detection module 201 is a rectangular box 400 (The rectangular box 400 may be the rectangular box 301 or the rectangular box 302). The four intercepts corresponding to the current face are d₁, d₂, d₃, and d₄, respectively, and the four slopes are m₁, m₂, m₃, and m₄, respectively. The object detection module 201 can obtain a straight line 401 on the plane of the image 300 based on the intercept d₁ and the slope m₁. Similarly, the object detection module 201 can obtain straight lines 402 to 404 on the plane of the image 300 based on the intercepts d₂, d₃ and d₄ and the corresponding slopes m₂, m₃, and m₄. The object detection module 201 can obtain four triangles 4003 to 4006 at four corners of the rectangular box 400 of the current face based on intersections of the lines 401 to 404 and the rectangular box 400. The object detection module 201 deletes the four triangles 4003 to 4006 at the four corners of the rectangular box 400 of the current face to obtain an octagonal box 405. As shown in FIG. 5A, after the rectangular box 301 and the rectangular box 302 are processed, an octagonal box 501 and an octagonal box 502 can be obtained.

In some embodiments of the present disclosure, the object detection module 201 obtains the intercepts d₁, d₂, d₃, and de based on four ratios r₁, r₂, r₃, and r₄, and a length d of one side (upper side 4001) of the rectangular box 400 of the current face, where d₁=r₁d, d₂=r₂d, d₃=r₃d, and d₄=r₄d.

In some embodiments of the present disclosure, the object detection module 201 multiplies lengths d (an upper side 4001 and a lower side 4002 have a same length) of upper and lower sides (upper side 4001 and lower side 4002) of the rectangular box 400 by a preset ratio r to obtain the intercepts d₁, d₂, d₃, and d₄ (where d₁=d₂=d₃=d₄=rd). The object detection module 201 sets the slopes m₁, m₂, m₃, and m₄ with an absolute value of a preset slope. For example, the absolute value of the preset slope is m. Since the slope of the line 401 in a coordinate system illustrated in FIG. 4 is negative, the object detection module 201 sets m₁=−m, and since the slope of the line 404 is positive, the object detection module 201 sets m₄=m. Based on the same reason, the object detection module 201 sets m₂=m, and m₃=−m. In some embodiments of the present disclosure, the preset ratio r is 0.25, and the absolute value of the preset slope m is 0.25.

It is worth noting that based on the previous flows, boxes of other polygons can also be obtained, and the present disclosure does not limit a range of a face with an octagonal box. A user shall set an appropriate polygon according to usage requirements.

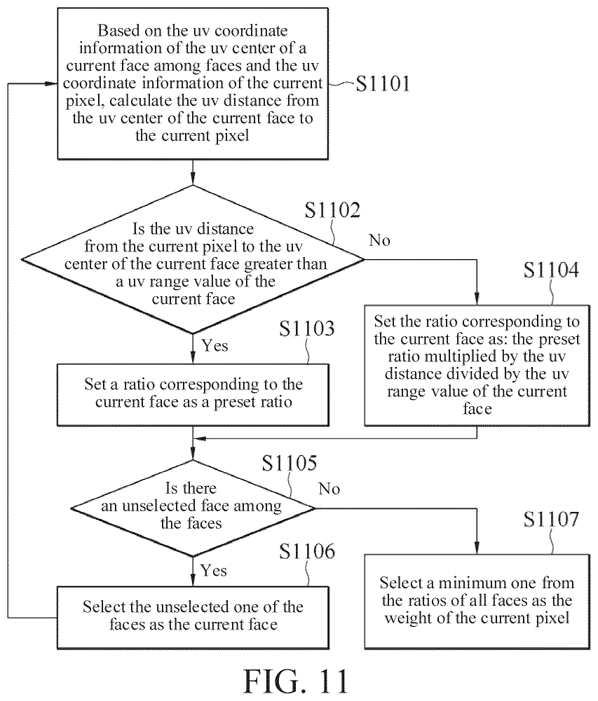

FIG. 10 is a flowchart of an image processing method illustrated according to some embodiments of the present disclosure. Referring to both FIG. 8 and FIG. 10, in an embodiment of FIG. 10, the coordinate information of the current pixel includes uv coordinate information, and the position information of each face includes uv coordinate information of a uv center and uv range information, where the uv center of the face is the center of the face in uv coordinates, and the uv range information includes a uv range value, representing a range of the face in a uv coordinate system. The aforementioned uv coordinate system is a texture coordinate system. Since the texture coordinate system is a two-dimensional coordinate system, each point in the texture coordinate system includes a first coordinate value and a second coordinate value. The uv coordinate information included in the coordinate information of the current pixel is texture coordinate information of the current pixel. In this embodiment, when at least one face is detected in an image by the object detection module 201, the object detection module 201 also detects the uv coordinate information of the uv center and the uv range information of each face based on an object detection algorithm.

Step S805 includes executing step S1001 by the weight calculation module 202. In step S1001, based on the uv coordinate information of the uv center of each face and the uv coordinate information of the current pixel, for the uv center of each face, a uv distance from the uv center of the face to the current pixel is calculated to obtain a uv distance from the uv center of each face to the current pixel. Finally, based on the uv distances of all faces, a weight of the current pixel is obtained.

FIG. 11 is a flowchart of an image processing method illustrated according to some embodiments of the present disclosure. Referring to FIG. 8, FIG. 10 to FIG. 11, following an embodiment of FIG. 10, when the object detection module 201 detects at least one face in an image, the object detection module 201 also detects the uv range information of each face based on an object detection algorithm and stores the uv range information in a memory for subsequent use. That is, in this embodiment, after the object detection module 201 detects the uv range information of each face based on the object detection algorithm, the uv range information will be stored in the memory for each detected face. In this embodiment, step S1001 includes executing steps S1101 to S1107 by the weight calculation module 202. In step S1101, based on the uv coordinate information of the uv center of a current face among faces and the uv coordinate information of the current pixel, the uv distance from the uv center of the current face to the current pixel is calculated.

In step S1102, whether the uv distance from the current pixel to the uv center of the current face is greater than a uv range value in the uv range information of the current face or not is judged. If yes, execute step S1103, and if no, execute step S1104. In step S1103, a ratio corresponding to the current face is set as a preset ratio, that is, the weight calculation module 202 sets the ratio corresponding to the current face with the preset ratio.

In step S1104, in response to the uv distance from the current pixel to the uv center of the current face being less than or equal to the uv range value in the uv range information, the ratio corresponding to the current face is set as: the preset ratio multiplied by the uv distance divided by the uv range value of the current face. In step S1105, whether there is an unselected face among the faces or not is judged. If yes, execute step S1106, and if no, execute step S1107. In step S1106, in response to there being an unselected face among the faces, the unselected one of the faces is selected as the current face and return to step S1101 to further execute steps S1101 to S1107. In step S1107, in response to the faces being all selected, a minimum one which is selected from the ratios corresponding to all faces is selected as the weight of the current pixel. In some embodiments of the present disclosure, the preset ratio is 64.

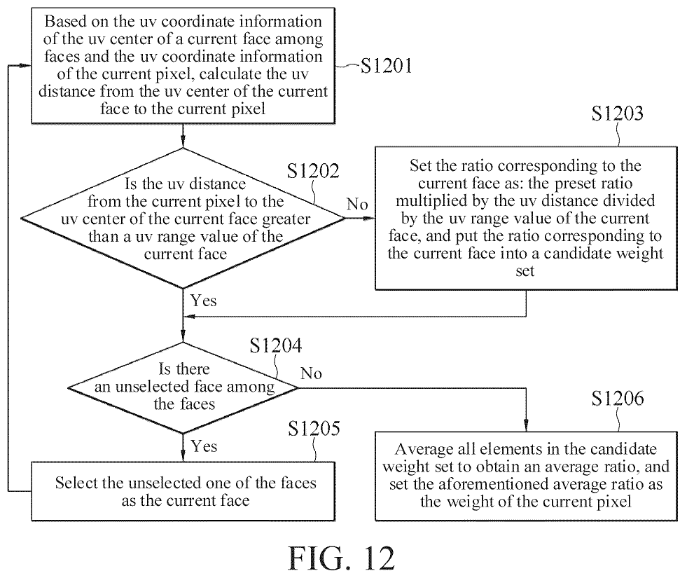

FIG. 12 is a flowchart of an image processing method illustrated according to some embodiments of the present disclosure. Referring to FIG. 8, FIG. 10 to FIG. 12, following an embodiment of FIG. 10, when the object detection module 201 detects at least one face in an image, the object detection module 201 also detects the uv range information of each face based on an object detection algorithm and stores the uv range information in a memory for subsequent use. That is, in this embodiment, after the object detection module 201 detects the uv range information of each face based on the object detection algorithm, the uv range information will be stored in the memory for each detected face. In this embodiment, step S1001 includes executing steps S1201 to S1206 by the weight calculation module 202. In step S1201, based on the uv coordinate information of the uv center of a current face among faces and the uv coordinate information of the current pixel, the uv distance from the uv center of the current face to the current pixel is calculated.

In step S1202, whether the uv distance from the current pixel to the uv center of the current face is greater than a uv range value in the uv range information of the current face or not is judged. If yes, execute step S1204, and if no, execute step S1203. In step S1203, in response to the uv distance from the current pixel to the uv center of the current face being less than or equal to the uv range value in the uv range information of the current face, the ratio corresponding to the current face is set as: the preset ratio multiplied by the uv distance divided by the uv range value of the current face, and the ratio corresponding to the current face is put into a candidate weight set. That is, let uvdistance represents the uv distance from the current pixel to the uv center of the current face, uvrange_currentface represents the uv range value of the current face, and preratio represents the preset ratio, then the ratio of the current face is set as

$$preratio \times \frac{uvdistance}{uvrange\_currentface} .$$

In step S1204, whether there is an unselected face among the faces or not is judged. If yes, execute step S1205, and if no, execute step S1206. In step S1205, in response to there being an unselected face among the faces, the unselected one of the faces is selected as the current face and return to step S1201 to further execute steps S1201 to S1206. In step S1206, in response to the faces being all selected, all elements of the candidate weight set are averaged to obtain an average ratio, and the average ratio is set as the weight of the current pixel.

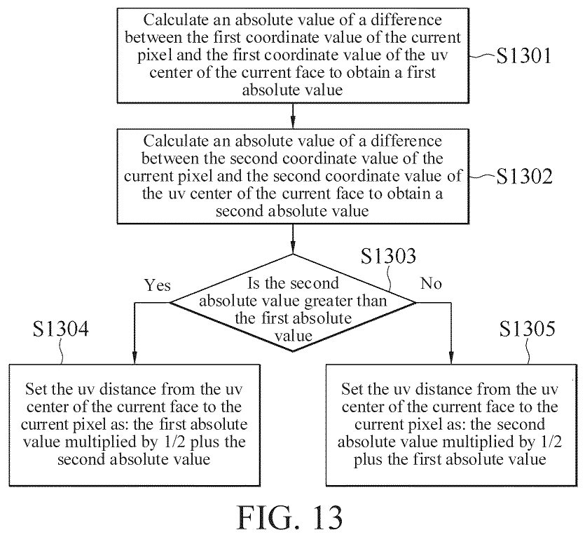

FIG. 13 is a flowchart of an image processing method illustrated according to some embodiments of the present disclosure. Referring to FIG. 11, FIG. 12, and FIG. 13, the uv coordinate information of the uv center of the current face includes a first coordinate value and a second coordinate value, and the uv coordinate information of the current pixel includes a first coordinate value and a second coordinate value. When the object detection module 201 detects at least one face in an image, the object detection module 201 also detects the first coordinate value and the second coordinate value of uv coordinates of the uv center of each face based on an object detection algorithm. The step of calculating the uv distance from the uv center of the current face to the current pixel in steps S1101 and S1201 include steps S1301 to S1305.

In step S1301, an absolute value of a difference between the first coordinate value of the current pixel and the first coordinate value of the uv center of the current face is calculated to obtain a first absolute value. In step S1302, an absolute value of a difference between the second coordinate value of the current pixel and the second coordinate value of the uv center of the current face is calculated to obtain a second absolute value. In step S1303, whether the second absolute value is greater than the first absolute value or not is judged. If yes, execute step S1304, and if no, execute step S1305. In step S1304, in response to the second absolute value being greater than the first absolute value, the uv distance from the uv center of the current face to the current pixel is set as: the first absolute value multiplied by ½ plus the second absolute value. In step S1305, in response to the second absolute value being less than or equal to the first absolute value, the uv distance from the uv center of the current face to the current pixel is set as: the second absolute value multiplied by ½ plus the first absolute value.

If the first coordinate value of the current pixel is represented with fᵤ, the second coordinate value of the current pixel is represented with fᵥ, the first coordinate value of the uv center of the current face is represented with centerᵤ, the second coordinate value of the uv center of the current face is represented with centerᵥ, the absolute value of the difference between the first coordinate value of the current pixel and the first coordinate value of the uv center of the current face is represented with tᵤ, the absolute value of the difference between the second coordinate value of the current pixel and the second coordinate value of the uv center of the current face is represented with tᵥ, and the uv distance from the uv center of the current face to the current pixel is represented with uvdistance, then steps S1301 to S1305 can be represented with the following C++ pseudocode:

$${t}_{u} = abs ( {f}_{u} - {center}_{u} )$$

$${t}_{v} = abs ( {f}_{v} - {center}_{v} ) ;$$

$$uvdistance = {t}_{v} - {t}_{u} ? ( {t}_{v} + {t}_{u} / 2 ) : ( {t}_{u} + {t}_{v} / 2 ) ;$$

where abs( ) is a function provided by the C++ language to calculate absolute values.

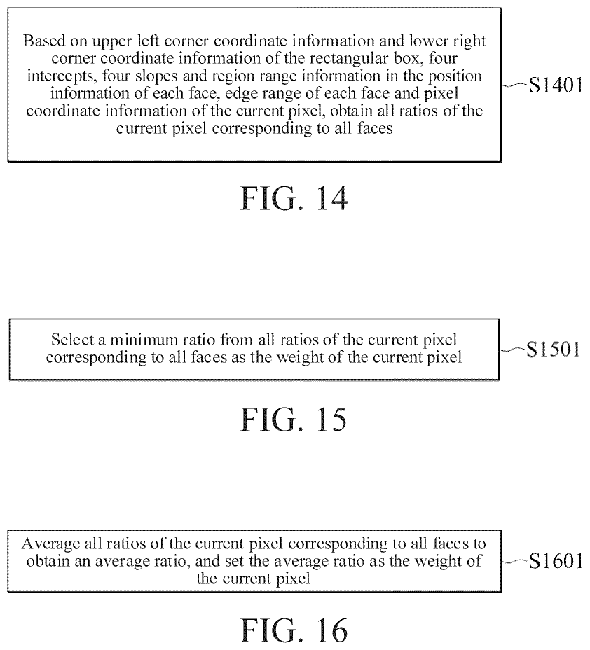

FIG. 14 is a flowchart of an image processing method illustrated according to some embodiments of the present disclosure. Referring to both FIG. 8 and FIG. 14, the polygon is an octagon. The coordinate information of the current pixel includes pixel coordinate information. The position information of each face includes upper left corner coordinate information and lower right corner coordinate information of a rectangular box, four intercepts, four slopes, and region range information. The object detection module 201 obtains a rectangular box of each face in a received image, the upper left corner coordinate information and the lower right corner coordinate information of the rectangular box, and the region range information based on an object detection algorithm. The region range information includes a region range value, representing a range of a region covered by the faces. The pixel coordinate information included in the coordinate information of the current pixel includes pixel coordinates of the current pixel. The upper left corner coordinate information of the rectangular box of each face includes pixel coordinates of the upper left corner of the rectangular box, and the lower right corner coordinate information of the rectangular box of each face includes pixel coordinates of the lower right corner of the rectangular box, where the pixel coordinates are coordinates in pixels in the image. The pixel coordinates of each point in the received image include a first coordinate value and a second coordinate value. Four intercepts and slopes of each face are used for deleting four triangles at four corners of the rectangular box of the face to obtain an octagonal box. In this embodiment, the weight calculation module 202 stores a preset edge range for each face.

Step S805 includes executing step S1401 by the weight calculation module 202. In step S1401, based on the upper left corner coordinate information and the lower right corner coordinate information of the rectangular box, the four intercepts, the four slopes and the region range information in the position information of each face, the edge range of each of the at least one face and the pixel coordinate information of the current pixel in the position information of each face, at least one ratio of the current pixel corresponding to at least one face is obtained by the weight calculation module 202.

FIG. 5B to FIG. 5C are schematic diagrams of operation of an image processing system illustrated according to some embodiments of the present disclosure. Referring to FIG. 5B to FIG. 5C and FIG. 14, following an embodiment of FIG. 14, the object detection module 201 detects N faces in the image 203, and the weight calculation module 202 executes the following steps: (1) storing the first coordinate value and the second coordinate value of the pixel coordinates of the upper left corner of the rectangular box of each face detected by the object detection module 201 in an array starti[ ] and an array startj[ ], respectively; (2) storing the first coordinate value and the second coordinate value of the pixel coordinates of the lower right corner of the rectangular box of each face detected by the object detection module 201 in an array endi[ ] and an array endj[ ], respectively; (3) storing the intercept and slope (e.g., d₁ and m₁ in FIG. 4) of the upper left corner of a corresponding rectangular box of each face detected by the object detection module 201 in an array jLU[ ] and an array jLUm[ ], respectively, storing the intercept and slope (e.g., d₂ and m₂ in FIG. 4) of the lower left corner of a corresponding rectangular box of each face detected by the object detection module 201 in an array jLD[ ] and an array jLDm[ ], respectively, storing the intercept and slope (e.g., d₄ and m₄ in FIG. 4) of the upper right corner of a corresponding rectangular box of each face detected by the object detection module 201 in an array jRU[ ] and an array jLRm[ ], respectively, and storing the intercept and slope (e.g., d₃ and m₃ in FIG. 4) of the lower right corner of a corresponding rectangular box of each face detected by the object detection module 201 in an array jRD[ ] and an array jRDm[ ], respectively; and (4) storing the region range value included in the region range information of each face detected by the object detection module 201 in an array AI_region_range[ ]. In this embodiment, the weight calculation module 202 stores an edge range for each face, and the aforementioned edge ranges corresponding to each face is a preset value and stored in the array AI_edge_range[ ]. Since the aforementioned data is stored in arrays, a corresponding numerical value can be obtained by an index value of a corresponding face. For example, jLD[k] represents the intercept of the lower left corner of a corresponding rectangular box of the face with the index value of k, and AI_edge_range[k] represents the edge range of the face with the index value of k. In this embodiment, since the object detection module 201 detects the N faces in the image 203, the range of k is from 0 to N−1.

In this embodiment, the weight calculation module 202 sets an array aiRatio6face[ ] to store the ratio of the current pixel corresponding to each face. The first coordinate value of the current pixel is represented with xi. The second coordinate value of the current pixel is represented with xj, and meanwhile, a variable zdist and finalRatio are set for calculation. Then the ratio of the current pixel corresponding to the face with the index value of k can be obtained with the following C++ pseudocode:

$$zdist = 0 ;$$

$$z = starti [ k ] - xi , zdist = Max ( zdist , z ) ;$$

$$z = xi - endi [ k ] ; zdist = Max ( zdist , z ) ;$$

$$z = startj [ k ] - xj , zdist = Max ( zdist , z ) ;$$

$$z = xj - endj [ k ] ; zdist = Max ( zdist , z ) ;$$

$$z = startj [ k ] + jLU [ k ] - xj ;$$

$$z = starti [ k ] + ( z / pow ( 2 , 1 + jLUm [ k ] ) ) - xi ;$$

$$zdist = Max ( zdist , z ) ;$$

$$z = startj [ k ] + jRU [ k ] - xj ;$$

$$z = xi - endi [ k ] + ( z / pow ( 2 , 1 + jRUm [ k ] ) ) ;$$

$$zdist = Max ( zdist , z ) ;$$

$$z = xj - endj [ k ] + jLD [ k ] ;$$

$$z = starti + ( z / pow ( 2 , 1 + jLDm [ k ] ) ) - xi ;$$

$$zdist = Max ( zdist , z ) ;$$

$$z = xj - endj [ k ] + jRD [ k ] ;$$

$$z = xi - endi [ k ] + ( z / pow ( 2 , 1 + jRDm [ k ] ) ) ;$$

$$zdist = Max ( zdist , z ) ;$$

$$if zdist <= AI\_edge \_range [ k ] :$$

$$if zdist == 0 :$$

$$finalRatio = 0 ;$$

$$else :$$

$$finalRatio = 64 * ( zdist / AI\_edge \_range [ k ] ) ;$$

$$else :$$

$$finalRatio = 64 ;$$

$$aiRatio 6 face [ k ] = finalRatio ;$$

where Max( ) is a function provided by the C++ language, and its function is to take a parameter with a larger value from parameters and return the taken parameter. Pow( ) is a function provided by the C++ language, and its function is to return a result of an exponential operation taking a second parameter as an exponent of a first parameter. For example, pow(a,b) will return a^{b}. By Letting k=0, 1, 2 . . . . N−1 sequentially and executing the aforementioned pseudocode, the ratio of the current pixel corresponding to each face can be obtained. As can be seen from the aforementioned C++ pseudocode, if the current pixel is located within the octagonal box, zdist=0, and at this time, the ratio of the current pixel corresponding to the face is 0. If the current pixel is not located within an octagonal box, zdist is not 0. In a case where zdist is not 0, the ratio of the current pixel corresponding to the face will be set according to the ratio of zdist to AI_edge_range[k]. The setting of finalRatio will be further explained with reference to FIG. 5B to FIG. 5D. A face 503 is a face detected by the object detection module 201. The object detection module 201 obtains an octagonal box 504 of the face 503 based on the aforementioned steps. Referring to FIG. 5C, in an example of FIG. 5C, the edge range corresponding to the face 503 is set as 0. At this time, based on the aforementioned C++ pseudocode, it can be seen that the ratio of each pixel within a range 505 defined by the octagonal box 504 corresponding to the face 503 is calculated as 0 (because zdist is 0 in the octagonal box 504), and the ratio of each pixel in the range 505 represented in black corresponding to the face 503 is calculated as 0 with the aforementioned C++ pseudocode. The ratio of each pixel outside the octagonal box 504 corresponding to the face 503 is calculated as 64 with the aforementioned C++ pseudocode.

Referring to FIG. 5D, in an example of FIG. 5D, the edge range corresponding to the face 503 is set as a non-zero positive number (e.g., 32). At this time, based on the aforementioned C++ pseudocode, it can be seen that the ratio of each pixel within the range 505 defined by the octagonal box 504 corresponding to the face 503 is calculated as 0 (because zdist is 0 in the octagonal box 504). In a case where zdist is not 0 but less than or equal to the edge range, the ratio of the current pixel corresponding to the face will be set as a value less than 64 but greater than 0 according to 64*(zdist/AI_edge_range[k]). In FIG. 5D, a range 506 represents a range where finalRatio is not 64. Regarding the values of 0 to 64 represented in gray scale within the range 506, the closer to white, the closer to 64 the value of finalRatio is, and the closer to black, the closer to 0 the value of finalRatio is.

FIG. 15 is a flowchart of an image processing method illustrated according to some embodiments of the present disclosure. Referring to FIG. 8, FIG. 14, and FIG. 15, following an embodiment of FIG. 14, in step S805, after step S1401, the weight calculation module 202 executes step S1501 to obtain the weight of the current pixel. In step S1501, a minimum ratio is selected from the at least one ratio of the current pixel corresponding to at least one face (stored in the array aiRatio6face[ ]) as the weight of the current pixel.

FIG. 16 is a flowchart of an image processing method illustrated according to some embodiments of the present disclosure. Referring to FIG. 8, FIG. 14, and FIG. 16, following an embodiment of FIG. 14, in step S805, after step S1401, the weight calculation module 202 executes step S1601 to obtain the weight of the current pixel. In step S1601, at least one ratio of the current pixel corresponding to the at least one face (stored in the array aiRatio6face[ ]) is averaged to obtain an average ratio. The weight calculation module 202 sets the average ratio as the weight of the current pixel.

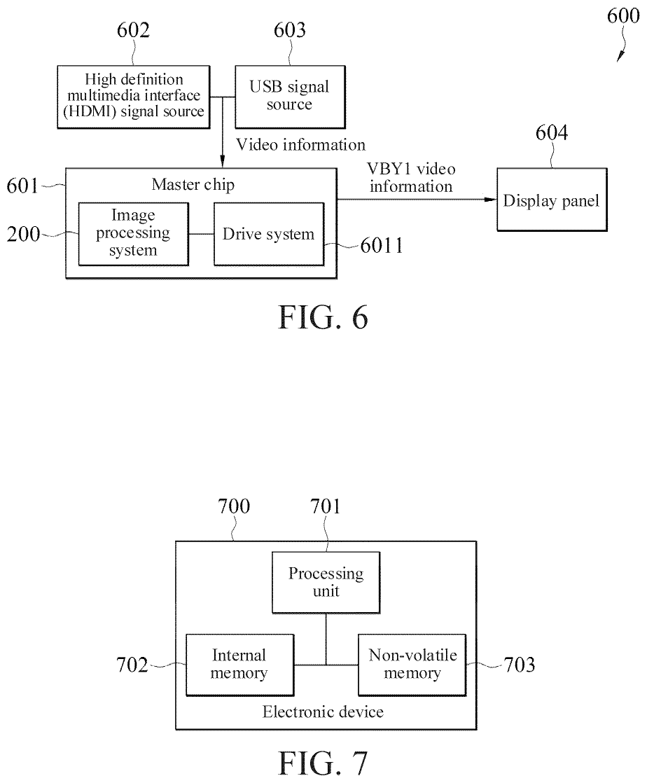

FIG. 6 is a block diagram of a display system illustrated according to some embodiments of the present disclosure. In an embodiment of FIG. 6, a display system 600 includes a master chip 601, a high definition multimedia interface (HDMI) signal source 602, a USB signal source 603, and a display panel 604. The master chip 601 includes an image processing system 200 and a drive system 6011. The master chip 601 receives video data from the HDMI signal source 602 or the USB signal source 603. The image processing system 200 takes each frame of the video data as the image 203, and processes the image 203 based on the obtained weight in a case where a face is detected, and then, a processed image 203 is transmitted to the drive system 6011 to drive the display panel 604 for display.

FIG. 7 is a schematic structural diagram of an electronic device illustrated according to some embodiments of the present disclosure. In this embodiment, an architecture of the master chip 601 is an electronic device 700 as shown in FIG. 7. The electronic device 700 includes a processing unit 701, an internal memory 702, and a non-volatile memory 703. The internal memory 702, for example, is a random-access memory (RAM). The processing unit 701 is a processor. The internal memory 702 and the non-volatile memory 703 are configured to store a program, where the program may include a program code. The program code includes a computer operating instruction. The processing unit 701 reads a corresponding computer program from the non-volatile memory 703 into the internal memory 702 and then runs the computer program for implementing the object detection module 201 and the weight calculation module 202 at a logic level.

Based on the above, according to the image processing system and the image processing method provided by some embodiments of the present disclosure, the range of each face is obtained based on the shape of the polygon, and thereby the area of a non-face region and the area of a face overlapping region can be effectively reduced, and thus side effects brought by a non-face part marked as a face region are alleviated; and the weight of a corresponding pixel is obtained based on the coordinate information of each pixel in the region covered by the ranges of all faces and the position information of each face, and thereby, brightness and chroma can be adjusted based on the weight of the corresponding pixel.

What is claimed is:

1. An image processing system, comprising an object detection module and a weight calculation module, wherein the object detection module is configured to execute the following steps:
(a1) receiving an image and detecting the image based on an object detection algorithm; and
(a2) in response to detecting at least one face, obtaining a range of each of the at least one face based on a shape of a polygon; where the weight calculation module is configured to execute the following steps on a plurality of pixels in a region covered by the ranges of all of the at least one face:
(b1) based on coordinate information of a current pixel among the pixels and position information of each of the at least one face, obtaining a weight of the current pixel; and
(b2) in response to there being an unselected pixel among the pixels, selecting the unselected one of the pixels as the current pixel and returning to step (b1).

2. The image processing system according to claim 1, wherein the polygon is an octagon, and step (a2) comprises the following steps to obtain the range of each of the at least one face:
(a21) obtaining a rectangular box of each of the at least one face based on the object detection algorithm;
(a22) based on four intercepts and four slopes of a current face among the at least one face, deleting four triangles at four corners of the rectangular box of the current face to obtain an octagonal box, wherein a range comprised in the octagonal box is taken as the range of the current face; and
(a23) in response to there being an unselected face among the at least one face, selecting the unselected one of the at least one face as the current face and returning to step (a22).

3. The image processing system according to claim 2, wherein the object detection module is configured to obtain the intercepts based on four ratios and a length of one side of the rectangular box of the current face.

4. The image processing system according to claim 1, wherein the coordinate information of the current pixel comprises uv coordinate information, and the position information of each of the at least one face comprises uv coordinate information of a uv center and uv range information, and step (b1) comprises:
(b11) based on the uv coordinate information of the uv center of each of the at least one face and the uv coordinate information of the current pixel, for the uv center of each of the at least one face, calculating a uv distance to the current pixel; and based on the uv distances of all of the at least one face and the uv range information, obtaining a weight of the current pixel.

5. The image processing system according to claim 4, wherein the uv range information comprises a uv range value, and step (b11) comprises:
(b111) based on the uv coordinate information of the uv center of a current face among the at least one face and the uv coordinate information of the current pixel, calculating the uv distance from the uv center of the current face to the current pixel;
(b112) in response to the uv distance from the current pixel to the uv center of the current face being greater than the uv range value of the current face, setting a ratio corresponding to the current face as a preset ratio; and in response to the uv distance from the current pixel to the uv center of the current face being less than or equal to the uv range value of the current face, setting the ratio corresponding to the current face as: a preset ratio multiplied by the uv distance divided by the uv range value of the current face; and
(b113) in response to there being an unselected face among the at least one face, selecting the unselected one of the at least one face as the current face and returning to step (b111); and in response to the at least one face being selected, selecting a minimum one from the ratios of all of the at least one face as the weight of the current pixel.

6. The image processing system according to claim 4, wherein the uv range information comprises a uv range value, and step (b11) comprises:
(b111) based on the uv coordinate information of the uv center of a current face among the at least one face and the uv coordinate information of the current pixel, calculating the uv distance from the uv center of the current face to the current pixel;
(b112) in response to the uv distance from the current pixel to the uv center of the current face being greater than the uv range value of the current face, executing step (b113); in response to the uv distance from the current pixel to the uv center of the current face being less than or equal to the uv range value of the current face, setting a ratio corresponding to the current face as: a preset ratio multiplied by the uv distance divided by the uv range value of the current face; and putting the ratio corresponding to the current face into a candidate weight set; and
(b113) in response to there being an unselected face among the at least one face, selecting the unselected one of the at least one face as the current face and returning to step (b111); and in response to the at least one face being selected, averaging all elements in the candidate weight set to obtain an average ratio, and setting the average ratio as the weight of the current pixel.

7. The image processing system according to claim 5, wherein the uv coordinate information of the uv center of the current face comprises a first coordinate value and a second coordinate value, the uv coordinate information of the current pixel comprises a first coordinate value and a second coordinate value, and the aforementioned step of calculating the uv distance from the uv center of the current face to the current pixel comprises:
calculating an absolute value of a difference between the first coordinate value of the current pixel and the first coordinate value of the uv center of the current face to obtain a first absolute value;
calculating an absolute value of a difference between the second coordinate value of the current pixel and the second coordinate value of the uv center of the current face to obtain a second absolute value; and
in response to the second absolute value being greater than the first absolute value, setting the uv distance from the uv center of the current face to the current pixel as: the first absolute value multiplied by ½ plus the second absolute value; and in response to the second absolute value being less than or equal to the first absolute value, setting the uv distance from the uv center of the current face to the current pixel as: the second absolute value multiplied by ½ plus the first absolute value.

8. The image processing system according to claim 1, wherein the polygon is an octagon, corresponding to each of the at least one face, an edge range is preset, the coordinate information of the current pixel comprises pixel coordinate information, the position information of each of the at least one face comprises upper left corner coordinate information and lower right corner coordinate information of a rectangular box, four intercepts, four slopes, and region range information, and step (b1) comprises:
(b11) based on the upper left corner coordinate information and the lower right corner coordinate information of the rectangular box, the four intercepts, the four slopes and the region range information in the position information of each of the at least one face, the edge range of each of the at least one face, and the pixel coordinate information of the current pixel, obtaining at least one ratio of the current pixel corresponding to the at least one face.

9. The image processing system according to claim 8, wherein step (b1) comprises:
(b12) selecting a minimum ratio from the at least one ratio of the current pixel corresponding to the at least one face as the weight of the current pixel.

10. The image processing system according to claim 8, wherein step (b1) comprises:
(b12) averaging the at least one ratio of the current pixel corresponding to the at least one face to obtain an average ratio, and setting the average ratio as the weight of the current pixel.

11. An image processing method, comprising:
(a) executing, by an object detection module, the following steps:
(a1) receiving an image and detecting the image based on an object detection algorithm; and
(a2) in response to detecting at least one face, obtaining a range of each of the at least one face based on a shape of a polygon; and
(b) executing, by a weight calculation module, the following steps on a plurality of pixels in a region covered by the ranges of all of the at least one face:
(b1) based on coordinate information of a current pixel among the pixels and position information of each of the at least one face, obtaining a weight of the current pixel; and
(b2) in response to there being an unselected pixel among the pixels, selecting the unselected one of the pixels as the current pixel and returning to step (b1).

12. The image processing method according to claim 11, wherein the polygon is an octagon, and step (a2) comprises the following steps to obtain the range of each of the at least one face:
(a21) obtaining a rectangular box of each of the at least one face based on the object detection algorithm;
(a22) based on four intercepts and four slopes of a current face among the at least one face, deleting four triangles at four corners of the rectangular box of the current face to obtain an octagonal box, wherein a range comprised in the octagonal box is taken as the range of the current face; and
(a23) in response to there being an unselected face among the at least one face, selecting the unselected one of the at least one face as the current face and returning to step (a22).

13. The image processing method according to claim 12, wherein step (a2) comprises: obtaining, by the object detection module, the intercepts based on four ratios and a length of one side of the rectangular box of the current face.

14. The image processing method according to claim 11, wherein the coordinate information of the current pixel comprises uv coordinate information, and the position information of each of the at least one face comprises uv coordinate information of a uv center and uv range information, and step (b1) comprises:
(b11) based on the uv coordinate information of the uv center of each of the at least one face and the uv coordinate information of the current pixel, for the uv center of each of the at least one face, calculating a uv distance to the current pixel; and based on the uv distances of all of the at least one face and the uv range information, obtaining a weight of the current pixel.

15. The image processing method according to claim 14, wherein the uv range information comprises a uv range value, and step (b11) comprises:
(b111) based on the uv coordinate information of the uv center of a current face among the at least one face and the uv coordinate information of the current pixel, calculating the uv distance from the uv center of the current face to the current pixel;
(b112) in response to the uv distance from the current pixel to the uv center of the current face being greater than the uv range value of the current face, setting a ratio corresponding to the current face as a preset ratio; and in response to the uv distance from the current pixel to the uv center of the current face being less than or equal to the uv range value of the current face, setting the ratio corresponding to the current face as: a preset ratio multiplied by the uv distance divided by the uv range value of the current face; and
(b113) in response to there being an unselected face among the at least one face, selecting the unselected one of the at least one face as the current face and returning to step (b111); and in response to the at least one face being selected, selecting a minimum one from the ratios of all of the at least one face as the weight of the current pixel.

16. The image processing method according to claim 14, wherein the uv range information comprises a uv range value, and step (b11) comprises:
(b111) based on the uv coordinate information of the uv center of a current face among the at least one face and the uv coordinate information of the current pixel, calculating the uv distance from the uv center of the current face to the current pixel;
(b112) in response to the uv distance from the current pixel to the uv center of the current face being greater than a uv range value of the current face, executing step (b113); and in response to the uv distance from the current pixel to the uv center of the current face being less than or equal to the uv range value of the current face, setting a ratio corresponding to the current face as: a preset ratio multiplied by the uv distance divided by the uv range value of the current face, and putting the ratio corresponding to the current face into a candidate weight set; and
(b113) in response to there being an unselected face among the at least one face, selecting the unselected one of the at least one face as the current face and returning to step (b111); and in response to the at least one face being selected, averaging all elements in the candidate weight set to obtain an average ratio, and setting the average ratio as the weight of the current pixel.

17. The image processing method according to claim 15, wherein the uv coordinate information of the uv center of the current face comprises a first coordinate value and a second coordinate value, the uv coordinate information of the current pixel comprises a first coordinate value and a second coordinate value, and the aforementioned step of calculating the uv distance from the uv center of the current face to the current pixel comprises:
calculating an absolute value of a difference between the first coordinate value of the current pixel and the first coordinate value of the uv center of the current face to obtain a first absolute value;
calculating an absolute value of a difference between the second coordinate value of the current pixel and the second coordinate value of the uv center of the current face to obtain a second absolute value; and
in response to the second absolute value being greater than the first absolute value, setting the uv distance from the uv center of the current face to the current pixel as: the first absolute value multiplied by ½ plus the second absolute value; and in response to the second absolute value being less than or equal to the first absolute value, setting the uv distance from the uv center of the current face to the current pixel as: the second absolute value multiplied by ½ plus the first absolute value.

18. The image processing method according to claim 11, wherein the polygon is an octagon, corresponding to each of the at least one face, an edge range is preset, the coordinate information of the current pixel comprises pixel coordinate information, the position information of each of the at least one face comprises upper left corner coordinate information and lower right corner coordinate information of a rectangular box, four intercepts, four slopes, and region range information, and step (b1) comprises:
(b11) based on the upper left corner coordinate information and the lower right corner coordinate information of the rectangular box, the four intercepts, the four slopes and the region range information in the position information of each of the at least one face, the edge range of each of the at least one face, and the pixel coordinate information of the current pixel, obtaining at least one ratio of the current pixel corresponding to the at least one face.

19. The image processing method according to claim 18, wherein step (b1) comprises:
(b12) selecting a minimum ratio from the at least one ratio of the current pixel corresponding to the at least one face as the weight of the current pixel.

20. The image processing method according to claim 18, wherein step (b1) comprises:
(b12) averaging the at least one ratio of the current pixel corresponding to the at least one face to obtain an average ratio, and setting the average ratio as the weight of the current pixel.
